(19) United States
(12) Patent Application Publication
(10) Pub. No.: US 2026/0265599 A1
(43) Pub. Date: Sep. 10, 2026

(54) Heat Transfer System with Organic, Non-Ionic Inhibitors Compatible with Flux Exposure in Fuel Cell Operations

(71) Applicant: CCI North America Corporation, Lemont, IL (US)

(72) Inventors: Timo WEIDE, Lockport, IL (US); Aleksei GERSHUN, Glenview, IL (US)

(21) Appl. No.: 18/718,386

(22) PCT Filed: Dec. 15, 2022
(86) PCT No.: PCT/IB2022/000763

§ 371 Date: Jun. 10, 2024

Related U.S. Application Data
(60) Provisional application No. 63/291,258, filed on Dec. 17, 2021.

(51) Int. Cl. C09K 5/20; H01M 8/04029; H01M 10/6567

(52) U.S. Cl. CPC C09K 5/20; H01M 8/04029; H01M 10/6567

(57) ABSTRACT

An aqueous coolant composition particularly useful for batteries and fuel cell contains an aliphatic alcohol having unsaturated bonds and/or a sulfur bond in the molecules thereof or a stabilized non-ionic silicate. The composition may also contain five-membered heterocyclic compounds, azole derivatives. The coolant composition possesses both low electrical conductivity and good antifreeze properties.

### CROSS-REFERENCE TO PRIOR APPLICATIONS

This is a national stage application filed under 37 U.S.C. 371 based on International Patent Application No. PCT/IB2022/000763, filed on 15 Dec. 2022, which claims priority to U.S. Provisional Patent Application 63/291,258, filed on 17 Dec. 2021.

### U.S. GOVERNMENT SUPPORT

N/A

### BACKGROUND OF THE INVENTION

Area of the Art. The present invention relates to heat transfer agents for cooling systems in electric vehicles having fuel cells and/or batteries.

### DESCRIPTION OF THE BACKGROUND ART

Heat transfer fluids (e.g., coolants) for internal combustion engines (“ICEs”) are known. Such fluids commonly contain about 50% water and 50% ethylene glycol (by weight) with trace amounts of additives, including corrosion inhibitors. A drawback of such coolants is the significant toxicity of ethylene glycol. Furthermore, the long-range future for ICEs is questionable because the ICE may become obsolete within the coming decades. Electric vehicles (EVs) are the most likely replacement for ICEs. EVs use efficient electric motors to covert electricity into mechanical energy for powering a vehicle. A portable source of electricity is essential for EVs. Currently, electrochemical batteries are the leading sources of portable electricity for EVs. A battery stores electrical energy from the grid in a chemical form. Thus, a battery powered EV is as clean as the source of energy used to produce electricity for the grid. Battery Electric Vehicles (BEVs) still use typical ICE-type coolants to cool batteries and motors.

Fuel cells have emerged as a potential replacement for electrochemical batteries in EVs. In general, a fuel cell is an electrochemical device that converts the chemical energy of a fuel into electrical energy. Fuel cells provide several advantages over ICE. Fuel cells are more efficient in extracting energy from fuel (e.g., 60-70% efficiency as compared to 40% for turbodiesel engines and 30% for gasoline engines). Further, fuel cells are quiet and produce negligible emissions of pollutants. With EVs powered by fuel cells coolants are still important both for the electric motor and for the fuel cell itself. With direct and indirect cooling for battery and fuel cell electric systems under development, low conductivity coolants ideal for electrical systems might increase even more in importance and possibly replace ethylene glycol-based coolants in the future due to safety reasons (both because of glycol toxicity and because non-conductive coolants prevent accidental short circuits).

Fuel cells and/or batteries for mobile use, particularly in motor vehicles, must be capable of operating at low exterior temperatures of down to about −40° C.; yet these same power sources often require a cooling system; for fuel cells cooling may be needed to deal with heat generated by fuel cell operation whereas for batteries a cooling system may be needed for dealing with heat generated by rapid charging or discharging. A freezing-protected coolant circuit is therefore indispensable. Such a freezing-protected heat transfer agent may become oxidized during use thereby producing ionic substances. Such ionic substances raise electrical conductivity of the coolant which could result in the “short circuiting” of the power source. The coolant paths of a fuel cell system are therefore generally provided with an ion-exchanger or an ion exchange resin to remove any such ionic substances. The capacity of the ion exchanger deteriorates as time goes by because the ion exchanger is “consumed” in the removal of the ionic substances. Therefore, with time ion-exchange resins need to be replaced or regenerated to maintain required purity of the cooling system. Periodically, the coolant and ion-exchange resin need to be replaced to prevent potential corrosion and glycol degradation products accumulation which could result to increased conductivity and potential system failure.

Conventional coolant compositions, such as those used in internal combustion engines, cannot be used with fuel cells and/or battery systems unless there is complete electric insulation of the cooling channels, because these conventional compositions have an undesirably high electrical conductivity due to salts and ionizable compounds used as corrosion inhibitors. The presence of significant numbers of positive and negative ions in a solution provides a path for a “stray electrical current.” Such stray current must be limited for several reasons. First, it may cause electrical shock hazards to the fuel cell operator. Second, such stray current may generate highly explosive hydrogen gas in the cooling system from hydrolysis. Lastly, a significant portion of the electricity generated by the fuel cell may be shorted through the fluid, rather than going to power production, thereby decreasing the efficiency of the fuel cell assembly. Thus, heat transfer fluids used in a fuel cell application must have lower electrical conductivities (i.e., higher electrical resistance) than those used in an ICE application. Accordingly, both low electrical conductivity and good antifreeze properties are required of heat transfer fluids for fuel cell and battery systems.

Accordingly, there have been several prior art attempts to solve this coolant problem.

DE-A 198 02 490 describes fuel cells having a freezing-protected cooling circuit in which a paraffinic isomer mixture having a pour point of less than −40° C. is used as a coolant. Unfortunately, the combustibility of such a petroleum-based coolant is disadvantageous.

EP-A 1 009 050 discloses a fuel cell system for automobiles, in which air is used as cooling medium. However, this approach has the disadvantage that air is a significantly less effective heat conductor than a liquid cooling medium.

US 2003/0198847 A1 describes fuel cell coolants comprising alcohols and polyalkene oxides.

WO 00/17951 describes a cooling system for fuel cells, in which a pure ethylene glycol/water mixture in a ratio of 1:1 without additives is used as coolant. To provide corrosion protection for materials present in the cooling system, the cooling circuit includes an ion-exchange unit to maintain the purity of the coolant and ensure a low specific conductivity over a prolonged time, thereby preventing short circuits and corrosion. As suitable ion exchangers, mention is made of anionic resins such as those of the strongly alkaline hydroxyl type and cationic resins such as those based on sulfonic acid groups as well as other filtration materials such as activated carbon.

WO 02/101848 describes antifreeze compositions for cooling systems in fuel cell drives and concentrates thereof which comprise specific azole derivatives. These antifreeze compositions display good corrosion protection on aluminum samples but fail to satisfy modern requirements in respect of corrosion of iron and nonferrous metals.

DE-A 100 63 951 describes coolants for cooling systems in fuel cell drives, which comprise ortho-silicic esters as corrosion inhibitors.

WO 2018/095759 relates to coolants for cooling systems in electric vehicles having fuel cells and/or batteries based on alkylene glycols or derivatives thereof, which comprise additional corrosion inhibitors for improved corrosion protection in addition to specific azole derivatives.

WO 2010/055160 A2 relates to an acidic aqueous composition containing a thiodiglycol alkoxylate for treating metallic surfaces. The invention also relates to the use of at least one compound in this class as a corrosion inhibitor.

WO 2005/033364 (8) describes alkanol-alkoxylates as corrosion inhibitors for strongly acidic applications.

As already mentioned, a significant problem in cooling systems in fuel cell and/or battery drives is, compared to conventional coolants, maintenance of a low electrical conductivity of the coolant to ensure safe and malfunction-free function of the fuel cell and batteries connected thereto and to prevent short circuits and corrosion in the long term. Besides conductivity increase due to glycol degradation and corrosion during coolant circulation the coolant can also be exposed to different type of metals, elastomers, as well as materials left in the cooling system unintentionally as result of manufacturing processes, such as during assembly of aluminum heat exchange and heater cores during the CAB (controlled aluminum brazing) process.

Therefore, it is an object of the present invention to provide antifreeze compositions that are corrosion-preventing for metals other than aluminum. Accordingly, it is an object of the present invention to provide an antifreeze coolant composition for a fuel cell or battery unit, which maintains low electrical conductivity of the coolant for long periods of time by suppressing generation of ionic substances in the coolant.

### SUMMARY OF THE INVENTION

The coolant composition of the present invention is characterized by containing at least one aliphatic alcohol having unsaturated bonds (A) in the molecules thereof or a stabilized non-ionic silicate. The coolant composition of the present invention can be characterized by containing an aliphatic alcohol having a sulfur bond (B) in the molecules thereof. The coolant composition of the present invention is characterized by containing five-membered heterocyclic compounds, azole derivatives (C), in the molecules thereof. The base component of this coolant composition possesses both low electrical conductivity and good antifreeze properties. Preferably, the base component contains at least one ingredient selected from the group consisting of water, glycols, saturated alcohols, and glycol ethers.

The invention provides ready-to-use aqueous coolant compositions which have a conductivity of not more than 50 μS/cm, preferably not more than 25 μS/cm, particularly preferably mot more than 10 μS/cm and in particular not more than 5 μS/cm, and consist essentially of:
(a) from 10 to 90% by weight of alkylene glycols or derivatives thereof,
(b) from 90 to 10% by weight of water,
(c) from 0.005 to 5% by weight, in particular from 0.0075 to 2.5% by weight, especially from 0.01 to 1% by weight, of the azole derivatives (C), and
(d) from 0.05 to 15% by weight, in particular from 0.1 to 10% by weight, especially from 0.2 to 5% by weight, of at least one of the compounds (A) and (B), and a stabilized non-ionic silicate wherein the sum of all components is 100% by weight.

The ready-to-use aqueous coolant compositions of the invention have an initial electrical conductivity of not more than 50 μS/cm, in particular 25 μS/cm, preferably 10 μS/cm, especially 5 μS/cm. The conductivity is maintained at this low level over a long period of time during long-term operation of the fuel cell or battery system, particularly when the cooling system has an integral ion exchanger.

The pH of the ready-to-use aqueous coolant compositions of the invention decreases significantly more slowly over the period of operation than in the case of cooling liquids to which the reagents (A), (B), (C), and a stabilized non-ionic silicate mentioned above have not been added. The pH is usually in the range from pH 4.5 to 7 in the case of fresh coolant compositions according to the invention and in long-term operation usually decreases to pH 3.5. The ion-free water used for dilution can be pure distilled or twice-distilled water or water which has been deionized, for example by ion exchange.

The preferred mixing ratio by weight of alkylene glycol or derivatives thereof to water in the ready-to-use aqueous coolant compositions is from 20:80 to 80:20, in particular from 25:75 to 75:25, preferably from 65:35 to 35:65, especially from 60:40 to 40:60. Suitable alcohols include monohydric or polyhydric alcohols and mixtures thereof. As alkylene glycol or polygycol component or derivative thereof, it is possible to use, in particular, monoethylene glycol, diethylene glycol, 1,2 propylene glycol, 1,3 propylene glycol, butylene glycol, glycerol, 1,2,6-hexanetriol, triethylene glycol, tetraethylene glycol and mixtures thereof, but also monopropylene glycol, dipropylene glycol and mixtures thereof, and glycol ethers, for example monoethylene glycol monomethyl ether, diethylene glycol monomethyl ether, triethylene glycol monomethyl ether, tetraethylene glycol monomethyl ether, monoethylene glycol monoethyl ether, diethylene glycol monoethyl ether, triethylene glycol monoethyl ether, tetraethylene glycol monoethyl ether, monoethylene glycol mono-n-butyl ether, diethylene glycol mono-n-butyl ether, triethylene glycol mono-n-butyl ether and tetraethylene glycol mono-n-butyl ether, in each case either alone or as mixtures thereof. Preferred monohydric alcohols are methanol, ethanol, propanol, butanol, furfurol, and tetrahydrofurfuryl alcohol (“THFA). More preferably, the alcohol is ethylene glycol, 1,2-propylene glycol, 1,3-propylene glycol, glycerol, and mixtures thereof. Particular preference is given to monoethylene glycol alone or mixtures of monoethylene glycol as main component, i.e., having a content in the concentrate of more than 50% by weight, in particular more than 80% by weight, especially more than 95% by weight, with other alkylene glycols or derivatives of alkylene glycols.

The present invention also provides for the use of at least one of the compounds for producing antifreeze concentrates for cooling systems in fuel cells and/or batteries, in particular in motor vehicles, particularly preferably in passenger cars and commercial vehicles, based on alkylene glycols or derivatives thereof.

The antifreeze concentrates of the invention themselves, from which the above-described ready-to-use aqueous coolant compositions result, can be produced by dissolving the derivatives mentioned in alkylene glycols or derivatives thereof, which can be used in water-free form or with a low water content (up to about 10% by weight, preferably up to 5% by weight).

### DESCRIPTION OF THE FIGURES

FIG. 1 is a photograph showing the experimental results of exemplary compositions A and B;

FIG. 2 is a photograph showing the experimental results of exemplary compositions C and D;

FIG. 3 is a photograph showing the experimental results of exemplary composition L; and

FIG. 4 is a photograph showing the experimental results of exemplary composition K.

### DETAILED DESCRIPTION OF THE INVENTION

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide a coolant composition that prevents corrosion and resists increases in electrical conductivity.

In the following paragraphs, a coolant composition for fuel cells and battery systems according to the present invention is described in detail. The coolant composition of the present invention is characterized by containing at least one aliphatic alcohol having (A) unsaturated bonds in the molecules thereof or a stabilized non-ionic silicate. The coolant composition of the present invention can be characterized by containing an aliphatic alcohol having (B) a sulfur bond in the molecules thereof. The coolant composition of the present invention is characterized by containing five-membered heterocyclic compounds, azole derivatives (C), in the molecules thereof. The base component of this coolant composition possesses low electrical conductivity and antifreeze properties. Preferably, the base component contains at least one ingredient selected from the group consisting of water, glycols, saturated alcohols, and glycol ethers.

The aliphatic alcohols possess unsaturated bonds (A) and/or sulfur bonds (B) in the molecules and maintain a low electrical conductivity. The stabilized non-ionic silicate also maintains a low electrical conductivity. The electrical conductivity of the coolant according to the present invention is maintained at 10 μS/cm or below, and the fluctuation in electrical conductivity of the coolant during a long use is maintained within the range from 0 μS/cm to 10 μS/cm.

The aliphatic alcohols of the present invention are not easily removed by the ion exchanger generally used in the cooling system and can maintain low electrical conductivity of the coolant for a long time. Because they are not removed by the ion exchanger, the expected function of the aliphatic alcohols according to the present invention will be long lasting without exhausting the ion exchanging capacity of the ion exchanger.

Preferably, in the aliphatic alcohols (A) having unsaturated bonds have 2 to 20 carbon atoms per molecule. Formula (I) shows the general structure of these compounds.

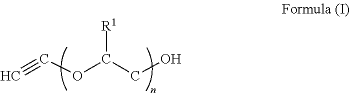

R¹ can be either —H or —CH₃ depending on whether ethylene oxide or propylene oxide, respectively, are used for the alkoxylation. Preferably, n=1 to 5.

The aliphatic alcohols of Formula (I) may be selected from Prop-2-yn-1-ol, allyl alcohol, 2-butyne-1,4-diol, 2-butene-1-ol, 3-butene-1-ol, 1-butene-3-ol, 2-methyl-2-propene-1-ol, 4-pentene-1-ol, 1-pentene-3-ol, 2-pentene-1-ol, 2-methyl-3-butene-2-ol, 3-methyl-2-butene-1-ol, 3-methyl-3-butene-1-ol, 2-hexene-1-ol, 3-hexene-1-ol, 4-hexene-1-ol, 5-hexene-1-ol, 1-hexene-3-ol, 6-heptene-1-ol, 2-heptene-1-ol, 4-heptene-1-ol, 7-octene-1-ol, 2-octene-1-ol, 3-octene-1-ol, 5-octene-1-ol, 3-octene-2-ol, 1-octene-3-ol, 2-nonene-1-ol, 3-nonene-1-ol, 6-nonene-1-ol, 8-nonene-1-ol, 1-nonene-3-ol, 2-decene-1-ol, 4-decene-1-ol, 9-decene-1-ol, 3,7-dimethyl-6-octene-3-ol, 2-undecene-1-ol, 10-undecence-1-ol, 2-dodecene-1-ol, 2-propyne-1-ol, 2-butyne-1-ol, 1-butyne-3-ol, 3-butyne-1-ol, 1-pentyne-3-ol, 2-pentyne-1-ol, 3-pentyne-1-ol, 4-pentyne-1-ol, 4-pentyne-2-ol, 3-methyl-1-butyne-3-ol, 1-hexyne-3-ol, 3-hexyne-1-ol, 5-hexyne-3-ol, 2-hexyne-1-ol, 5-hexyne-1-ol, 3-methyl-1-pentyne-3-ol, 2-cyclohexene-1-ol, 2,4-hexadiene-1-ol, 1-heptyne-3-ol, 2-heptyne-1-ol, 3-heptyne-1-ol, 4-heptyne-2-ol, 5-heptyne-3-ol, 5-methyl-1-hexyne-3-ol, 3,4-dimethyl-1-pentyne-3-ol, 3-ethyl-1-pentyne-3-ol, 3,5-dimethyl-1-hexyne-3-ol, 3-octyne-1-ol, 1-octyne-3-ol, 2,7-octadienol, 3,6-dimethyl-1-heptyne-3-ol, 3-ethyl-1-heptyne-3-ol, 3-nonyne-1-ol, 2,6-nonadiene-1-ol, 3,6-nonadiene-1-ol, 1-cyclohexyl-2-butene-1-ol, 2-decyne-1-ol, 3-decyne-1-ol, 2,4-decadiene-1-ol, 4-ethyl-1-octyne-3-ol, 3,7-dimethyl-2,6-octadiene-1-ol, 10-undecyne-1-ol, 2,4-undecadiene-1-ol, 2,4-dodecadiene-1-ol, 3-methyl-1-pentene-4-yn-3-ol, 1-ethynyl-1-cyclohexanol, 2-butene-1,4-diol, 2-butyne-1,4-diol, 3-butene-1,2-diol, 2-methylene-1,3-propanediol, 7-octene-1,2-diol, 2,5-dimethyl-3-hexyne-2,5-diol, 3,6-dimethyl-4-octyne-3,6-diol, 3-pentene-2-ol, 4-pentene-2-ol, 2-methyl-3-butene-1-ol, 5-hexene-2-ol, 3-methyl-1-pentene-3-ol, 4-methyl-3-pentene-1-ol, 4-methyl-2-cyclohexene-1-ol, 5-decene-1-ol, 3,7-dimethyl-6-octene-3-ol, 1,4-pentadiene-3-ol, 1,5-hexadiene-3-ol, 1,6-heptadiene-4-ol, 2-methyl-3-hexyne-2-ol, 1-ethynyl-1-cyclopentanol, 10-undecyne-1-ol, 1,5-hexadiene-3,4-diol, and 3,5-cyclohexadiene-1,2-diol.

Among these, Prop-2-yn-1-ol and 2-butyne-1,4-diol derivatives are preferred, and ethoxylated and/or propoxylated Prop-2-yn-1-ol and 2-butyne-1,4-diol derivatives are particularly preferred. In particular, alkoxylated unsaturated alcohols are particularly preferred due to their toxicological and ecological advantages over non-alkoxylated derivatives. The alkoxylated alcohols having unsaturated bonds are prepared by reacting Prop-2-yn-1-ol and 2-Butyne-1,4-diol with ethylene or propylene oxide under basic conditions until the desired average alkoxylation ratio of n=1-5 is reached. 2-(prop-2-ynyl)-ethanol is particularly preferred.

Preferably, the aliphatic alcohols (B) having a sulfur bond are ethoxylated or propoxylated Thiodiglycol derivatives with an average molecular weight from 500-1000 M. 2,2′-Thiobisethanol polymer with oxirane is particularly preferred. Formula (II) gives the general structure:

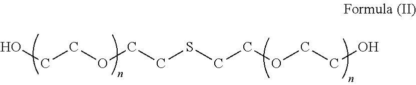

Preferably, n=1-10 for a symmetrically alkoxylated molecule.

Preferably, the five-membered heterocyclic compounds (azole derivatives) (C) usually contain two N atoms and no S atoms, three N atoms and no S atom or one N atom and one S atom as heteroatoms. Preferred groups of the specified azole derivatives are annellated imidazoles and annellated 1,2,3-triazoles of the general Formulae (IIIa) and (IIIb) where (IIIa) has an aromatic benzene ring and (IIIb) has a cyclohexyl ring.

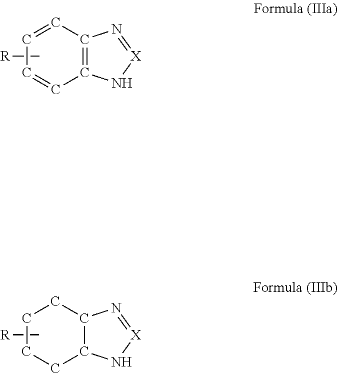

where the variable R is hydrogen or a C₁-C₁₀-alkyl radical, preferably methyl or ethyl, and the variable X is a nitrogen atom or the C H group.

Typical and preferred examples of azole derivatives (C) of the general Formula (II) are benzimidazole (X═C—H, R═H), benzotriazoles (X═N, R═H) and tolyltriazole (tolyltriazole) (X═N, R═CH₃). A typical example of an azole derivative of the general Formula (III) is hydrogenated 1,2,3-tolyltriazole (tolyltriazole) (X═N, R═CH₃).

A further preferred group of the specified azole derivatives are benzothiazoles of the general Formula (IIIc).

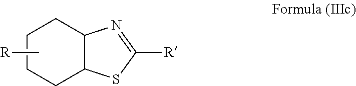

where the variable R is as defined above with Formulae (IIIa) and (IIIb), and the variable R′ is hydrogen, a C₁-C₁₀-alkyl radical, preferably methyl or ethyl, or a mercapto group (—SH). A typical example of an azole derivative of the general Formula (IIIc) is 2-mercaptobenzothiazole.

Further suitable azole derivatives are non-annellated azole derivatives of the general Formula (IIId.)

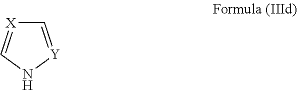

where the variables X and Y together are two nitrogen atoms or one nitrogen atom and a C—H group, for example 1H-1,2,4-triazole (X═Y═N) or preferably imidazole (X═N, Y═C—H)

For the purposes of the present invention azole derivatives include benzimidazole, benzotriazole, tolyltriazole, hydrogenated tolyltriazole or mixtures thereof, (benzotriazole or tolyltriazol, are very particularly preferred).

Preferably, a non-ionic stabilized silicate package is added. The non-ionic silicate package is prepared separately beforehand. In this case, an appropriate amount of the organic silane compound of Formula (V) is added to a solution of an orthosilicate ester of Formula (IV) in water or water/glycol, and the mixture is stirred at a temperature from 20° C. to 60° C., preferably from 30° C. to 40° C., for 10 to 24 hours. A catalyst and wetting agent/emulsifier is also added. Typical wetting agents are non-ionic surfactants like fatty alcohol alkoxylates (FAEs) and polysiloxanes or siloxane-polyether copolymers available from MOMENTIVE or other suppliers. In one exemplary embodiment, siloxane-based emulsifiers include SILWET L-77, SILWET L-7657, SILWET L-7650, SILWET L-7600, SILWET L-7200, SILWET L-7210 and the like. The ratio of the orthosilicate ester to the organic silane stabilizer is from 1:1 to 10:1, or preferably from 2:1 to 6:1. The resulting organosilane/orthosilicate ester copolymer, which contains about 20-90, preferably 30-75% by weight, based on the sum of the two reactants, Silane (Formula (V)) and orthosilicate ester (Formula (VI)), can then be added to the antifreeze coolant formulation containing the remaining components. The Silicon content as SiO₂ of the coolant concentrate is in weight proportions from 100 ppm to 1000 ppm, preferably from 200 ppm to 800 ppm, most preferably from 300 ppm to 600 ppm. The Silicon content can be adjusted according to the Si-content of the non-ionic silicate package. Organosilane compounds are those that are capable of hydrolyzing in the presence of water to form a silanol, that is, a compound comprising a silicon hydroxide (Si—OH bond). As the stabilized non-ionic silicate package is available with a defined Si-content, customized formulations can easily be prepared depending on different customer Si-content specifications or requirements with minimum blending complexity. In this case, a super-concentrate strategy can be applied where dilution of the standard inhibitor package, to which the non-ionic silicate package was added, with glycol and water will afford a finished coolant as needed by customer request.

The non-ionic silicate package contains an orthosilicate ester of the formula:

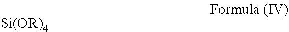

in which the R groups may be identical or different groups selected from C₁- to C₂₀-alkyls: e.g., tetramethylorthosilicate, tetraethylorthosilicate and the like, C₂- to C₂₀ alkenyl, C₁- to C₂₀-hydroxyalkyl, or in special cases substituted C₆- to C₁₂-aryl or glycolether-residues of the general formula (CH₂—CH₂—O)ₙR^{b} where R^{b} is hydrogen or R^{b} are C₁- to C₆-alkyl residues, and n is 1-5, and a combination thereof, is preferred. Alkoxyalkylsilanes, preferably triethoxymethylsilane, diethoxydimethylsilane, ethoxytrimethylsilane, trimethoxymethylsilane, dimethoxydimethylsilane and methoxytrimethylsilane can also be used. Under certain conditions dipodal hydrophobic or hydrophilic silanes like bis-(triethoxysilyl)-ethane can be used in combination with the before-mentioned reagents. Organic disilazanes of the type R₃SINHSiR₃ in which R can be an alkyl-, or an aryl-group between C₁ and C₃₆, or acetamides of the type SiR₃NH(C═O)R in which R can be an alkyl-, or aryl-group between C₁ and C₃₆, or acetamides of the type R₃Si(N═CR)—OSiR₃ in which R can be an alkyl-, or aryl-group between C₁ and C₃₆ can also be used.

The non-ionic silicate package is stabilized with an organic silane of the formula:

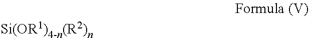

in which n is an integer or fraction ranging from 1 to 3, R¹ is an organic radical linked to the oxygen atom by a carbon-oxygen bond, a hydrogen atom, or an alkali metal and R² is an organic radical linked to the silicon atom by a silicon-carbon bond.

Antifreeze composition, characterized in that the radical R¹ of the organic silane is a linear or branched alkyl radical having from one to ten carbon atoms or a cyclic alkyl, aryl, or an alkyl radical having from 6 to 14 carbon atoms. Antifreeze composition, characterized in that the radical R² of the organic silane is a linear or branched alkyl radical having from one to ten carbon atoms or a cyclic alkyl, aryl, or an alkyl radical having from 6 to 14 carbon atoms, and can comprise a heteroatom such as N, S, O, or the like, in the form of functional groups such as amino groups, epoxy groups, or the like. Non-limiting examples of commercially available organosilane compounds include the SILQUEST and FORMASIL surfactants from MOMENTIVE, and other suppliers. In an exemplary embodiment, siloxane-based corrosion inhibitors or Si-stabilizers comprise FORMASIL 891, FORMASIL 593, FORMASIL 433, SILQUEST Y-5560 (polyalkyleneoxide-alkoxysilane), SILQUEST A-186 (2-(3,4-epoxycyclohexyl)-ethyltrimethoxysilane), SILQUEST A-187 (3-glycidoxypropyltrimethoxysilane), or other SILQUEST organosilane compounds available from MOMENTIVE or other suppliers. Other non-limiting examples of organosilane compounds for use herein include 3-aminopropyltriethoxysilane, N-2-(aminoethyl)-3-aminopropyltrimethoxysilane, octyltriethoxysilane, vinyltriethoxysilane, vinyltrimethoxysilane, methyltriethoxysilane, 3-methacryloxypropyltrimethoxysilane, 3-mercaptopropyltrimethoxysilane, isobutyltrimethoxysilane, phenyltrimethoxysilane, methyltrimethoxysilane, and those organosilane compounds having a structure similar to the foregoing, but varying numbers of carbon atoms. Most preferably, antifreeze composition, characterized in that the radical R² of the organic silane has the formula:

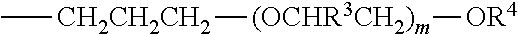

in which m is an integer or fraction between 1 and 20, R³ is a hydrogen atom or an alkyl radical and R⁴ is an alkyl radical having from 1 to 10 carbon atoms. Organosilane compounds for which the structure is unknown or which is outside the scope of this formula, like oligomeric silanes derived from above reagents, can also be suitable for use as siloxane-based corrosion inhibitors or Si-stabilizers.

The glycols preferably are selected from the group consisting of ethylene glycol, diethylene glycol, triethylene glycol, propylene glycol, 1,3-propanediol, 1,3-butanediol, 1,5-pentanediol and hexylene glycol.

The saturated alcohols preferably are selected from the group consisting of methanol, ethanol, propanol, butanol, pentanol, hexanol, heptanol and octanol.

The glycol ethers preferably may be an alkyl ether of a polyoxy alkylene glycol, such as ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether and tetraethylene glycol monobutyl ether.

The coolant composition of the present invention may additionally contain an antifoaming agent, a wetting agent, a coloring agent, etc.

According to the invention, the antifreeze compositions of the present invention comprise at least one compound selected from the group consisting of compounds of the Formula (I), compounds of the Formula (II), compounds of the Formula (III), a non-ionic silica package, and mixtures thereof. Among these, compounds of the Formulae (II) and (III) are preferred, and a non-ionic silica package is especially preferred. It has been observed that mixtures of derivatives of (I) and (II) show a synergistic effect against mixture of derivatives from the same group. Formulations with only derivatives of aliphatic alcohols with a sulfur bond (II) are least effective. It has also been found that the duration of a low electrical conductivity in a cooling system based on alkylene glycol/water can be lengthened by addition of even small amounts of azole-derivatives.

Accordingly, we have found heat transfer fluid compositions for cooling systems in fuel cells and/or batteries, from which ready-to-use aqueous coolant compositions having a conductivity of not more than 50 μS/cm result, based on alkylene glycols or derivatives thereof which comprise one or more five-membered heterocyclic compounds (azole derivatives) having two or three heteroatoms from the group consisting of nitrogen and sulfur and comprise no or at most one sulfur atom and can bear an aromatic or saturated six-membered fused-on ring, and additionally comprise at least one of the compounds of Formulae (I), (II), or a non-ionic silica package. Preference is here given to heat transfer fluid compositions which comprise a total of from 0.05 to 5% by weight, preferably from 0.075 to 2.5% by weight, more preferably from 0.1 to 1% by weight, of the azole derivatives mentioned. Preference is given here to fluid compositions which comprise a total of from 0.05 to 15% by weight, preferably from 0.1 to 10% by weight, more preferably from 0.2 to 5% by weight, of at least one of the compounds of Formulae (I), (II), and anon-ionic silica package.

Table 1 shows the respective components of examples A to L of the present invention and the comparison example. The freeze protecting base component consists of a mixture of 50:50% v/v of deionized water and ethylene glycol. To example A was added an ethoxylated thiodiglycol and Benzotriazole. To example C was added an ethoxylated thiodiglycol, propargyl alcohol propoxylate B, and Benzotriazole. To example D was added an ethoxylated thiodiglycol, a propagyl alcohol ethoxylate, and Benzotriazole. To example E was added an ethoxylated thiodiglycol, 2-Butyne-1,4-diol, and Benzotriazole. To example F was added propagyl alcohol ethoxylate, 2-Butyne-1,4-diol, and Benzotriazol. To example H was added propagyl alcohol propoxylate B, 2-Butyne-1,4-diol, and Benzotriazole. To example K was added an ethoxylated thiodiglycol, propagyl alcohol propoxylate A, and Benzotriazole. To example L was added Benzotriazole and a non-ionic silicate package. The Si-content of the final solution was adjusted to 100 ppm as Si. All reagents are industrial grade reagents and were not specially purified. Inhibitor content is described as parts by weight. Compositions A to L were subject to a submerging screening test at elevated temperature (Screening Oxidation Treatment=SOT).

TABLE 1

| | Example | Example | Example | Example | Example | Example | Example | Example |
|---|---|---|---|---|---|---|---|---|
| Inhibitor | A | C | D | E | F | H | K | L |
| Ethoxylated | 1.00 | 0.50 | 0.50 | — | — | — | — | — |
| Thiodiglycol | | | | | | | | |
| Propagyl | — | — | 0.50 | — | 0.50 | — | — | — |
| alcohol | | | | | | | | |
| ethoxylate | | | | | | | | |
| Propagyl | — | — | — | — | — | — | 0.50 | — |
| alcohol | | | | | | | | |
| propoxylate A | | | | | | | | |
| Propagyl | — | 0.50 | — | — | — | 0.50 | — | — |
| alcohol | | | | | | | | |
| propoxylate B | | | | | | | | |
| 2-Butyne- | — | | | 0.50 | 0.50 | 0.50 | — | — |
| 1,4-diol | | | | | | | | |
| Benzotriazole | 0.10 | 0.10 | 0.10 | 0.10 | 0.10 | 0.10 | 0.10 | 0.10 |
| Non-Ionic Si- | — | — | — | — | — | — | — | 100 ppm |
| Package | | | | | | | | Si |

The electrical conductivity, pH, and visual appearance after oxidation treatment of each example and comparison example was measured or evaluated. Special attention was given to changes in pH and conductivity. The results are shown in Table 2.

TABLE 2

| | | Example | Example | Example | Example | Example | Example | Example | Example |
|---|---|---|---|---|---|---|---|---|---|
| | Compare | A | C | D | E | F | H | K | L |
| pH initial | 6.60 | 8.76 | 6.9 | 6.30 | 6.17 | 5.95 | 4.85 | 5.00 | 5.32 |
| pH end | 5.22 | 5.71 | 5.45 | 5.59 | 5.21 | 5.21 | 4.76 | 5.26 | 4.85 |
| \|ΔpH\| | 1.38 | 3.05 | 1.04 | 0.71 | 0.96 | 0.74 | 0.09 | 0.26 | 0.47 |
| Conductivity | 0.50 | 3.15 | 2.52 | 11.97 | 2.57 | 10.86 | 4.49 | 3.06 | 4.4 |
| initial | | | | | | | | | |
| Conductivity | 11.31 | 12.23 | 5.04 | 14.52 | 8.36 | 14.57 | 8.87 | 6.20 | 4.64 |
| end | | | | | | | | | |
| Δ | 10.81 | 9.08 | 2.52 | 2.55 | 5.80 | 3.71 | 4.38 | 3.14 | 0.24 |
| Conductivity | | | | | | | | | |
| visual | black/ | brown/ | yellow/ | yellow/ | brown/ | yellow/ | yellow/ | yellow/ | Clear/ |
| | solids | solids | clear | clear | solids | solids | solids | clear | clear |

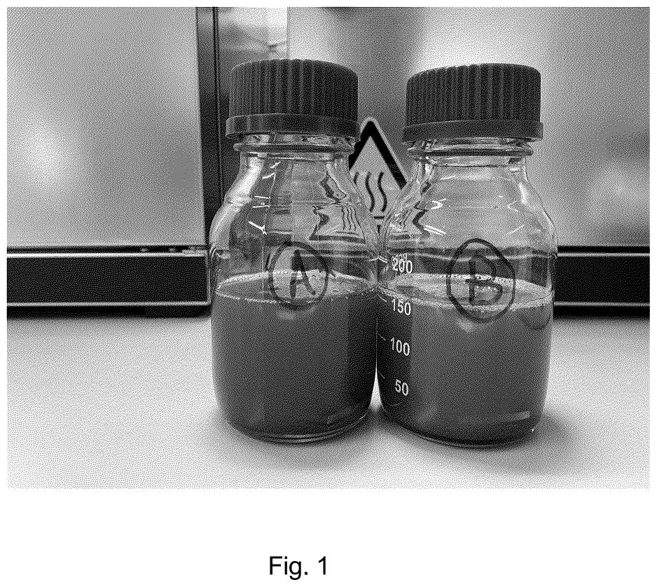

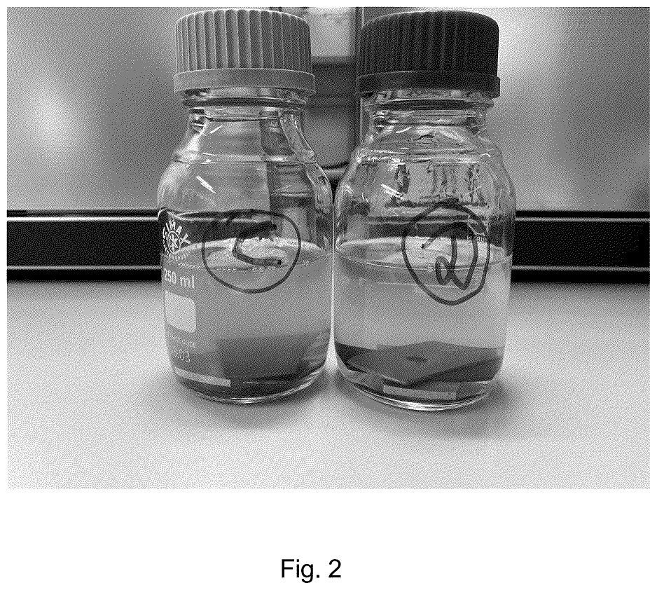

The screening oxidation treatment (SOT) of each sample was performed over 168 hours at 75° C. with ASTM D1384 steel (UNS G102000), aluminum (UNS A23190), and copper (UNS C11000) coupons submersed in the fluid. As Table 2 shows, the comparison sample and embodiments A to L had a low initial conductivity and a neutral pH, while the conductivity and pH change after oxidation was much larger for the comparison sample and sample A which contained only an ethoxylated thiodiglycol and Benzotriazole. FIG. 1 shows the appearance of Samples A and B following oxidation. In contrast, the pH and electrical conductivity change of samples C, D, E, F, H, and K which contained at least one aliphatic alcohol having unsaturated bonds (I) all remained lower within the range from 2.52 to 5.80 μS/cm after oxidation. Examples C, D, and K which contain both an aliphatic alcohol having unsaturated bonds (I) and an aliphatic alcohol having a sulfur bond (II) show an unexpected synergistic effect represented in the lowest pH and conductivity change. This is especially reflected in the visual appearance—examples C and D, and in particular example K, remain yellowish and clear after oxidation. FIG. 2 shows Examples C and D. Among the aliphatic alcohols having unsaturated bonds (A) 2-Butyne-1,4-diol is least effective as shown in sample E. Example L with the non-ionic silicate copolymer is most effective and stands out being a clear solution with no formation of solids. Formulation K and L were subject to a harsher corrosion test under laboratory modified ASTM D-1384 “Standard Test Method for Corrosion Test for Engine Coolants in Glassware” conditions. See Annual Book of ASTM Standards, section 15, for reference.

Two compositions, K and L, were prepared and evaluated under the conditions (modified as explained below) set forth by ASTM D1384. ASTM D1384 is a standard test method for general corrosion of a variety of metals typically found in the cooling system and/or heating system of internal combustion engines. ASTM D1384 was modified in order to evaluate the metals that will be used in fuel cell assembly. Such metals include stainless steel, aluminum alloys and copper. Stainless steel is a very inert material, that does not corrode readily unlike carbon steel. Therefore, to make a more rigorous test carbon steel instead of stainless steel was used. ASTM D1384 was further modified so that the test formulations K and L were not diluted with “corrosive water” (i.e., DI water containing 100 ppm each of SO₄, HCO₃, and Cl, all added as Na⁺-salts). Such dilution accounts for variations in water added to traditional antifreeze concentrates, which may not occur with regard to fuel cell heat transfer fluids.

After preparing the compositions K and L and subjecting them to the test procedures set forth in ASTM D1384 (the metal specimens were immersed for 336 hours in the heat transfer composition and maintained at a temperature of 88° C.), the weight change of the metal specimens were measured. A weight loss of 10 mg for each of copper, brass, steel and cast iron, and 30 mg for each of aluminum and solder is the maximum allowed to pass ASTM D1384. The results are shown in table 3.

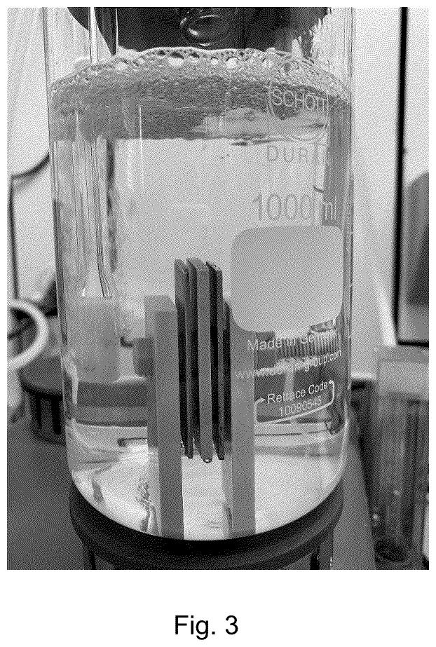

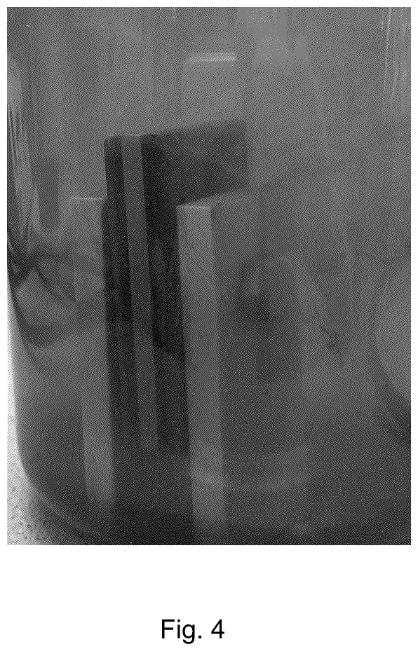

As shown in table 3, the heat transfer compositions of the present invention provide general corrosion inhibition for aluminum and copper. For example, Examples K and L exhibited copper loss of less than 10 mg/coupon, and aluminum loss of less than 30 mg/coupon. The stabilized non-ionic silicate in composition L (FIG. 3) is even capable of protecting carbon steel from corrosion compared to sample K (FIG. 4).

After completion of the modified ASTM D1384 test, electrical resistance was measured for compositions K and L. As shown in Table 3, the compositions of the present invention provide high electrical resistance even after exposure to different metal surfaces over extended test times.

TABLE 3

| | pH | pH | Cond. | Cond | Carbon | | | Cast | Flux |
|---|---|---|---|---|---|---|---|---|---|
| | (before) | (after) | (before) | (after) | Steel | Copper | Aluminum | Iron | Stability |
| L | 5.32 | 4.5 | 4.4 | 14.9 | 24.0 | 0.4 | 0.2 | — | 100% |
| K | 5.64 | 3.94 | 2.3 | 28.0 | 170.0 | 3.1 | 2.0 | — | N/A |

The compounds of the Formulae (I), (II), the non-ionic silicate package, and Formula (III) are particularly suitable for reducing ferrous and non-ferrous metal corrosion and maintaining low conductivity in the use of coolant compositions in fuel cells and battery systems and are accordingly added to the coolant compositions in a method according to the invention. The aliphatic alcohols contained in the fluid composition of the present invention prevents generation of ionic substances resulting from oxidation of the base component of the coolant and can maintain low electrical conductivity of the coolant for a long period of time. There is also evidence that derivatives (I) show cationic and/or possibly anionic corrosion protection. In addition, as the aliphatic alcohol in the coolant composition of the present invention is not easily removed by an ion exchanger in cooling systems, the duration of effectiveness of the ion exchanger is extended. The stabilized “non-ionic silicate” seems to function like a regular silicate, as in combustion engine coolants, and prevents generation of ionic substances resulting from corrosion and can maintain low electrical conductivity of the coolant for a long period of time.

Remaining flux residues from aluminum soldering processes result in the coolant-contained silicate corrosion inhibitors causing undesired precipitation and gelling, and therefore, the silicates are generally no longer used as corrosion inhibitors where there may be flux residues. Composition L, however, shows excellent flux stability and no Si-depletion or gelling as shown in Table 3. In this case, 40 ml coolant were placed in a 100 ml PE bottle with a screw cap and the initial Si-content was determined by ICP (inductively couple plasma) atomic absorption spectrophotometry. To this mixture 60 mg of NOCOLOK® Flux was added, and the mixture was homogenized by shaking, and, subsequently, the coolant mixture was heated and stored at 90° C. for 72 hours. Once the coolant reached room temperature again, 5 ml of each coolant was filtrated through a 0.45 μm filter and, subsequently, the silicon content was determined again. No depletion of silica was observed. These results are especially surprising as the stabilized non-ionic silicate combines both excellent corrosion protection and Flux stability. A feature which current state of the art fuel cell coolant lack.

The following claims are thus to be understood to include what is specifically illustrated and described above, what is conceptually equivalent, and what can be obviously substituted. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. A silicate-containing heat transfer fluid providing corrosion protection to metal surfaces of the type containing water, alkylene glycols, silicates and azole derivatives having a conductivity of not more than 50 μS/cm characterized in that the non-ionic additives of said heat transfer fluid are selected from 0.05 to 15% by weight in total of at least one of the following components:
an ethoxylated and/or propoxylated prop-2-yn-1-ol or 2-butyne-1,4-diol derivative with an average alkoxylation ratio of 1-5;
an ethoxylated and/or propoxylated thiodiglycol derivative with an average molecular weight from 500-1000 M; and
a stabilized non-ionic silicate component prepared with an organic silane which component does not cause silicate precipitation when exposed to flux residue from a soldering process.

2. The silicate-containing heat transfer fluid of claim 1 further comprising one or more of an antifoaming agent, a wetting agent, and a coloring agent.

3. The silicate-containing heat transfer fluid of claim 1, wherein the stabilized non-ionic silicate is prepared in advance in a water/alkylene glycol solution from an orthosilicate ester and a stabilizing silane along with a catalyst and a surfactant and is then added to the other components.

4. The silicate-containing heat transfer fluid of claim 1 or 3, wherein the stabilized non-ionic silicate is prepared from an orthosilicate ester of the general formula: 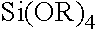
in which the R groups are selected from C1- to C20 alkyls; and
a stabilizing organic silane of the formula: 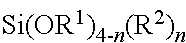
in which n is an integer or fraction ranging from 1 to 3, R¹ is an organic radical linked to the oxygen atom by a carbon-oxygen bond, or a hydrogen atom, R² is a non-ionic, organic radical linked to the silicon atom by a silicon-carbon bond, and wherein R² of the stabilizing silane is:
a linear or branched alkyl radical having from one to ten carbon atoms or a cyclic alkyl, or aryl radical, having from 6 to 14 carbon atoms, and can comprise a heteroatom; or
in which the radical R² has the formula: 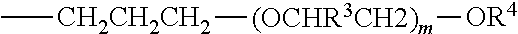
in which m is an integer or fraction between 1 and 20, R³ is a hydrogen atom or an alkyl radical and R4 is an alkyl radical having from 1 to 10 carbon atoms.

5. The silicate-containing heat transfer fluid of claim 4, wherein the Si-ratio of the orthosilicate ester Si(OR)₄ to the stabilizing organic silane Si(OR¹)₄₋ₙ(R²)ₙ is from 1:1 to 10:1.

6. The silicate-containing heat transfer fluid of claim 1, wherein the silicon concentration as SiO₂ is from 100 ppm to 1000 ppm.

7. The silicate-containing heat transfer fluid of claim 6, wherein the silicon concentration as SiO₂ is from 300 ppm to 600 ppm.
